(19) United States
(12) Patent Application Publication
(10) Pub. No.: US 2017/0146433 A1
(43) Pub. Date: May 25, 2017

(54) FAULT ISOLATION METHOD OF INDUSTRIAL PROCESS BASED ON REGULARIZATION FRAMEWORK

(71) Applicant: Northeastern University, Shenyang City (CN)

(72) Inventors: Yingwei ZHANG, Shenyang City (CN); Wenyou DU, Shenyang City (CN); Yunpeng FAN, Shenyang City (CN); Qilong JIA, Shenyang City (CN); Shitao LIU, Shenyang City (CN); Xu YANG, Shenyang City (CN)

(21) Appl. No.: 15/009,241

(22) Filed: Jan. 28, 2016

(30) Foreign Application Priority Data
Nov. 19, 2015 (CN) 201510816035.7

(51) Int. Cl. G01M 99/00

(52) U.S. Cl. CPC G01M 99/008

(57) ABSTRACT

Provided is a fault isolation method in industrial process based on regularization framework, including the steps of: collecting and filtering sample data in industrial process to obtain an available sample data set; establishing an objective function for fault isolation in industrial process with local and global regularization items; calculating the optimal solution to the objective function for fault isolation in industrial process by the available sample data set; obtaining a predicted classification label matrix according to the optimal solution to determine the fault information in the process. The method uses the local regularization item to make the nature of the optimal solution ideal, and uses the global regularization item to correct problem of low fault isolation precision caused by the local regularization item. Experiments show that the method is not only feasible but also provides high fault isolation precision and mining the potential information of labeled sample data.

### CROSS-REFERENCE TO RELATED APPLICATION

This application claims the priority of Chinese patent application No. 201510816035.7, filed on Nov. 19, 2015, which is incorporated herewith by reference.

### BACKGROUND OF THE INVENTION

1. Field of the Invention

The present invention belongs to the technical field of industrial process monitoring, in particular relates to a fault isolation method of industrial process based on regularization framework.

2. The Prior Arts

The fault means that one or more characteristics or variables in the system deviate from the normal state to a great extent. In a broad sense, the fault can be explained as all abnormal phenomena resulting in unexpected characteristics in the system. Once the system has a fault, the performance of the system may be reduced to below the normal level, so it is difficult to achieve the expected result and function. The fault which cannot be removed and solved in time may cause a production accident.

The industrial process monitoring technology is a discipline based on fault isolation technology and is used to conduct research on the enhancement of product quality, system reliability and device maintainability, having great significance for ensuring safe operation of complex industrial process.

The sample data generated in industrial process are mainly classified into labeled sample data and unlabeled sample data. The labeled sample data is usually difficult to acquire, because it is mainly restrained by the production condition of the actual work site and often needs labeling by experts or experienced workers in the field concerned, which is time-consuming and expensive. Therefore, the data generated in industrial process contains less labeled sample data and mostly is unlabeled sample data. How to reasonably use labeled sample data and unlabeled sample data to reduce the cost of manually labeling sample data becomes a hotspot of research on the fault isolation method based on data driven in recent years. However, the information of the labeled sample data has not been mined fully so far, so how to enhance the generalization ability of a classifier as much as possible in a small amount of labeled sample data not accurate enough and how to make full use of a large number of cheap unlabeled samples to enhance the precision of fault isolation have become hotspots of research in the fault isolation field.

### SUMMARY OF THE INVENTION

Aiming at the defects of the prior art, the present invention provides a fault isolation method of industrial process based on regularization framework.

The present invention has the following technical schemes.

A fault isolation method of industrial process based on regularization framework comprises the steps of:

step 1: collecting the sample data in industrial process;

step 2: filtering the collected sample data to remove singular sample data and retain available sample data; wherein the available sample data includes labeled sample data and unlabeled sample data; the labeled sample data is used by experienced experts or workers to differentiate the characteristics of the collected data and respectively label the collected data as normal sample data, fault sample data and categories of their corresponding fault states to enable these sample data to have classification labels; the unlabeled data is the data which is directly collected but not labeled and not having classification label, wherein the available sample data set is expressed as:

T=={(x₁,y₁), . . . (xₗ,yₗ)}∪{xₗ₊₁, . . . xₙ}; xⱼ∈R^{d}, j=1, . . . ,n (1)

wherein d is the number of variables; n is the number of samples; xᵢ|ᵢ₌₁^{l} is the labeled sample data, and xᵢ|ᵢ₌ₗ₊₁ⁿ is the unlabeled data; yᵢ∈{1, 2, . . . , c}, i=1, . . . , l, wherein c is the category of the fault state, and l is the number of the labeled samples;

step 3: establishing an objective function for fault isolation in industrial process,

$$J ( F ) = {min}_{F ∈ {R}^{n \times c}} tr ( {( F - Y )}^{T} D ( F - Y ) + \frac{γ}{{n}^{2}} {F}^{T} G F + {F}^{T} M F ) \qquad ( 2 )$$

wherein F is a predicted classification label matrix; tr is the trace symbol of the matrix; D is a diagonal matrix, wherein the diagonal elements are Dᵢᵢ=Dₗ>0, i=−1, . . . , l, Dᵢᵢ=Dᵤ≧0, and i=l+1, . . . , n; (F−Y)^{T}D(F−Y) is empirical loss used to measure the difference value between predicted classification label and initial classification label; γ is a regulation parameter;

$$\frac{γ}{{n}^{2}} {F}^{T} G F$$

is a global regularization item, and G is a global regularization matrix; F^{T}MF is a local regularization item, and M is a local regularization matrix; Y∈R^{n×c} is an initial classification label matrix, and the elements of Y are defined as follows:

$${Y}_{ij} = \{ \begin{matrix}1 , & \begin{matrix}if {x}_{i} is labeled as category j fault state , \\ j is one of category c fault\end{matrix} \\ 0 , & otherwise\end{matrix} \qquad ( 3 )$$

step 4: calculating the optimal solution F* for the objective function for fault isolation in industrial process shown in Formula (2) by the available sample data set;

step 5: obtaining the predicted classification label matrix by Formula (4) according to the optimal solution F* to determine the fault information in the process,

$${f}_{i} = {arg max}_{l \leq j \leq c} {F}_{ij}^{*} \qquad ( 4 )$$

wherein fᵢ is the predicted classification label of the sample point xᵢ; according to the fault isolation method of industrial process based on regularization framework, step 4 includes the steps of:

step 4.1: obtaining a global regularization matrix G according to the improved similarity measurement algorithm and k-nearest neighbor (KNN) classification algorithm.

wherein G can be calculated by Formula (5),

G=S−W∈R^{n×n} (5)

wherein Formula (5) is further improved by a regularized Laplacian matrix to obtain Formula (6):

$$G = I - {S}^{- \frac{1}{2}} {WS}^{- \frac{1}{2}} ∈ {R}^{n \times n} \qquad ( 6 )$$

wherein I is the unit matrix of k×k; S is a diagonal matrix, wherein the diagonal elements are

$${S}_{ii} = {\sum }_{j = 1}^{n} {W}_{ij} ,$$

i=1, 2, . . . , n; W∈R^{n×n}, and is a similarity matrix; W and the sample point xᵢ|ᵢ₌₁ⁿ form an undirected weighted graph with the vertex corresponding to the sample point and the edge Wᵢⱼ corresponding to the similarity of the sample points xᵢ|ᵢ₌₁^{l} and xⱼ|ⱼ₌₁^{l}; the precision of the final fault classification is determined by the calculation method of W, W is calculated by the method of local reconstruction using neighbor points of the sample point xᵢ, and the reconstruction error equation is as follows:

$${\sum }_{i = 1}^{n} {‖ {x}_{i} - {\sum }_{j = 1}^{k} {W}_{ij} {x}_{ij} ‖}^{2} \qquad ( 7 )$$

wherein

$${\sum }_{j = 1}^{k} {W}_{ij} = 1 ,$$

and the minimum value of Formula (7) is calculated to get W and then G by Formula (5); the specific steps for calculating W are as follows:

step 4.1.1: obtaining the distance measurement between xᵢ and its k neighbor points by the improved distance Formula (8) to calculate the distance between sample points, i.e., sample similarity measurement;

$${W}_{ij} = d ( {x}_{i} , {x}_{j} ) = \frac{‖ {x}_{i} - {x}_{j} ‖}{\sqrt{M ( i ) M ( j )}} \qquad ( 8 )$$

M(i) and M(j) respectively represent the average value of distances between the sample point xᵢ and its k neighbors and the average value of distances between the sample point xᵢ and its k neighbors;

step 4.1.2: converting Formula (8) to Formula (9) through kernel mapping;

$$d ( {x}_{i} , {x}_{j} ) = \frac{\sqrt{{K}_{ii} - 2 {K}_{ij} + {K}_{jj}}}{\sqrt{Δ}} \qquad ( 9 )$$

wherein Kᵢⱼ=Φ(xᵢ)^{T}Φ(xⱼ), Kᵢᵢ=Φ(xᵢ)^{T}Φ(xᵢ), Kⱼⱼ=Φ(xⱼ)^{T}Φ(xⱼ), and K is Mercer kernel; the numerator \sqrt{Kᵢᵢ−2Kᵢⱼ+Kⱼⱼ} of Formula (9) is obtained by deducing the numerator ∥xᵢ−xⱼ∥ of Formula (8) through kernel mapping, i.e., ∥Φ(xᵢ)−Φ(xⱼ)∥=\sqrt{∥Φ(xᵢ)−Φ(xⱼ)∥²}=\sqrt{Kᵢᵢ−2Kᵢⱼ+Kⱼⱼ}; in the denominator of Formula (9),

$$Δ = \frac{{\sum }_{p = 1}^{k} ( {K}_{ii} - {K}_{{ii}^{p}} - {K}_{{i}^{p} i} + {K}_{{i}^{p} {i}^{p}} ) {\sum }_{q = 1}^{k} ( {K}_{jj} - {K}_{{jj}^{p}} - {K}_{{j}^{p} j} + {K}_{{j}^{p} {j}^{p}} )}{{k}^{2}} ,$$

wherein Kᵢᵢ_{^{p}}=Φ(xᵢ)^{T}Φ(xᵢ^{p}); Kᵢ_{^{p}}ᵢ=Φ(xᵢ^{p})^{T}Φ(xᵢ); Kᵢ_{^{p}}ᵢ_{^{p}}=Φ(xᵢ^{p})^{T}Φ(xᵢ^{p}); Kⱼⱼ_{^{q}}=Φ(xⱼ)^{T}Φ(xⱼ^{q}); Kⱼ_{^{q}}ⱼ=Φ(xⱼ^{q})^{T}Φ(xⱼ); Kⱼ_{^{q}}ⱼ_{^{q}}=Φ(xⱼ^{q})^{T}Φ(xⱼ^{q}); xᵢ^{p} (p=1, 2 . . . k) is the p th neighbor point of xᵢ; xⱼ^{q} (q=1, 2 . . . k) is the q th neighbor point of xⱼ;

step 4.1.3: defining the sample similarity measurement, i.e., distance measurement between samples, by Formula (9) according to the labeled data and the unlabeled data among the collected data, expressed by Formula (10):

$$d ( {x}_{i} , {x}_{j} ) = \{ \begin{matrix}\sqrt{1 - exp ( - \frac{{‖ {x}_{i} - {x}_{j} ‖}^{2}}{β} )} - α , & \begin{matrix}when {x}_{i} and {x}_{j} \\ are labeled identically\end{matrix} \\ \sqrt{1 - exp ( - \frac{{‖ {x}_{i} - {x}_{j} ‖}^{2}}{β} )} & \begin{matrix}when {x}_{i} and {x}_{j} are unlabeled , \\ {x}_{j} ∈ {N}_{i} or {x}_{i} ∈ {N}_{j}\end{matrix} \\ \sqrt{exp ( - \frac{{‖ {x}_{i} - {x}_{j} ‖}^{2}}{β} ) ,} & otherwise\end{matrix} \qquad ( 10 )$$

wherein β is a control parameter depending on the distribution density of the collected sample data points; α is a regulation parameter;

step 4.1.4: getting k neighbors of the sample xᵢ by the distance measurement defined in Formula (10) to obtain the neighbor domain Nᵢ of xᵢ;

step 4.1.5: reconstructing xᵢ by k neighbor points of the sample xᵢ to calculate the minimum value of xᵢ reconstruction error, i.e., the optimal similarity matrix W:

$$arg min {\sum }_{i = 1}^{n} {‖ Φ ( {x}_{i} ) - {\sum }_{{x}_{j} ∈ {N}_{i}} {W}_{ij} Φ ( {x}_{j} ) ‖}^{2} \qquad ( 11 )$$

wherein Formula (7) is converted to Formula (11) through kernel mapping of sample points; ∥•∥ is an Euclidean norm; Wᵢⱼ has two constraint conditions:

$${\sum }_{{x}_{j} ∈ {N}_{i}} {W}_{ij} = 1 ,$$

and Wᵢⱼ=0 when xⱼ∉Nᵢ;

step 4.2: obtaining a local regularization matrix M;

step 4.3: obtaining the optimal solution F* of the objective function by making the partial derivative of the objective function J(F) for fault isolation in industrial process equal to 0;

$$\frac{\partial J}{\partial F} {\vert}_{F = {F}^{*}} = 2 D ( {F}^{*} - Y ) + 2 \frac{γ}{{n}^{2}} {GF}^{*} + 2 MF = 0 ⇒ ( D + \frac{γ}{{n}^{2}} G + M ) {F}^{*} = DY ⇒ {F}^{*} = {( D + \frac{γ}{{n}^{2}} G + M )}^{- 1} DY ; \qquad ( 12 )$$

according to the fault isolation method of industrial process based on regularization framework, step 4.2 includes the steps of:

step 4.2.1: determining k neighbor points of the sample point xᵢ through Euclidean distance, and defining the set of the k neighbor points as Nᵢ={ᵢ_{ⱼ}}ⱼ₌₁^{k}, wherein xᵢ_{ⱼ} represents the j th neighbor point of the sample point xᵢ;

step 4.2.2: establishing a loss function expressed by Formula (13) to cause sample classification labels to be distributed smoothly,

$$J ( {g}_{i} ) = {\sum }_{j = 1}^{k} {( {f}_{{i}_{j}} - {g}_{i} ( {x}_{{i}_{j}} ) )}^{2} + λ S ( {g}_{i} ) \qquad ( 13 )$$

wherein the first item is the sum of errors of the predicted classification labels and actual classification labels of all samples; λ is a regulation parameter; the second item S(gᵢ) is a penalty function; the function gᵢ: R^{m}→R, and

$${g}_{i} ( x ) = {\sum }_{j = 1}^{d} {β}_{i , j} {p}_{j} ( x ) + {\sum }_{j = 1}^{k} {α}_{i , j} {φ}_{i , j} ( x ) ,$$

which enable each sample point to reach a classification label through the mapping:

fᵢ_{ⱼ}=gᵢ(xᵢ_{ⱼ}), j=1,2, . . . ,k (14)

wherein fᵢ_{ⱼ} is the classification label of the j th neighbor point of the sample point xᵢ;

$$d = \frac{( m + s - 1 ) !}{m ! ( s - 1 ) !} ,$$

m is the dimension of x, and s is the partial derivative order of semi-norm; {pⱼ(x)}ᵢ₌₁^{d} constitutes polynomial space with the order not less than s, and 2s>m; φ_{i,j}(x) is a Green function; β_{i,j} and φ_{i,j} are two coefficients of the Green function;

step 4.2.3: obtaining the estimated classification label loss of the set Nᵢ of neighbor points of the sample point xᵢ by calculating the minimum value of the loss function established in step 4.2.2,

wherein for k dispersed sample data points, the minimum value of the loss function J(gᵢ(x)) can be estimated by Formula (15),

$$J ( {g}_{i} ) \approx {\sum }_{j = 1}^{k} {( {f}_{{i}_{j}} - {g}_{i} ( {x}_{{i}_{j}} ) )}^{2} + {λα}_{i}^{T} {H}_{i} {α}_{i} \qquad ( 15 )$$

wherein Hᵢ is the symmetric matrix of k×k, and its (r,z) elements are H_{r,z}=φ_{i,z}(xᵢ_{ᵣ}), αᵢ=[α_{i,1}, α_{i,2}, . . . , α_{i,k}]∈R^{k} and βᵢ=[β_{i,1}, β_{i,2}, . . . , β_{i,d-1}]^{T}∈R^{k};
wherein for a smaller λ, the minimum value of the loss function J(gᵢ(x)) can be estimated by the label matrix to obtain the estimated classification label loss of the set Nᵢ of neighbor points of the sample point xᵢ:

J(gᵢ)≈λFᵢ^{T}MᵢFᵢ (16)

wherein Fᵢ=[fᵢ_{₁}, fᵢ_{₂}, . . . , fᵢ_{ₖ}]∈R^{k} corresponds to the classification labels of k data in Nᵢ; Mᵢ is the upper left k×k subblock matrix of the inverse matrix of the coefficient matrix and is calculated by Formula (17):

αᵢ^{T}(Hᵢ+λI)αᵢ=Fᵢ^{T}MᵢFᵢ (17)

step 4.2.4: collecting the estimated classification label losses of the neighbor domains {Nᵢ}ᵢ₌₁ⁿ of n sample points together to obtain the total estimated classification label loss, and calculating the minimum value of the total loss E(f), i.e., the classification label of the sample data, so as to obtain the local regularization matrix M; the total estimated classification label loss is expressed by Formula (18),

$$E ( f ) \approx λ {\sum }_{i = 1}^{n} {F}_{i}^{T} {M}_{i} {F}_{i} \qquad ( 18 )$$

wherein f=[f₁, f₂, . . . , fₙ]^{T}∈Rⁿ is the vector of the classification label; wherein when the coefficient λ, in Formula (18) is neglected, Formula (18) is converted to Formula (19):

$$E ( f ) ∝ {\sum }_{i = 1}^{n} {F}_{i}^{T} {M}_{i} {F}_{i} \qquad ( 19 )$$

wherein according to the row selection matrix Sᵢ∈R^{k×n}, Fᵢ=Sᵢf; wherein the elements Sᵢ(u,v) in the u th row and the vth column of Sᵢ can be defined by Formula (20):

$${S}_{i} ( u , v ) = \{ \begin{matrix}1 , & if v = {i}_{u} \\ 0 , & otherwise\end{matrix} \qquad ( 20 )$$

wherein Fᵢ=Sᵢf is substituted into Formula (20) to obtain E(f)∝f^{T}Mf, wherein

$$M = {\sum }_{i = 1}^{n} {S}_{i}^{T} {M}_{i} {S}_{i} ,$$

The present invention has the following beneficial effect: the fault isolation using a large number of cheap unlabeled data samples for training on the basis of a small number of labeled data samples can effectively enhance the accuracy of fault isolation. To make full use of known labeled sample data, the method provided by the present invention uses the local regularization item to make the optimal solution have ideal nature, and uses the global regularization item to remedy the problem of insufficient fault isolation precision which may be caused by the local regularization item due to less samples in the neighbor domain so as to make the classification label smooth. The fault isolation method uses a small number of labeled data samples to train the fault isolation model of the system and makes full use of statistical distribution and other information of a large number of unlabeled data samples to enhance the generalization ability, overall performance and precision of the fault isolation model. Experiments show that the method provided by the present invention is not only feasible but also provides high fault isolation precision. It can be seen from experiments that the fault isolation effect of the experiments depends on the proportion of the labeled sample data and model parameters to a great extent.

### BRIEF DESCRIPTION OF THE DRAWINGS

FIG. 1 is the flow chart of the fault isolation method of industrial process based on regularization framework for one embodiment of the present invention.

FIG. 2 is the structural diagram of the hot galvanizing pickling waste liquor treatment process for one embodiment of the present invention.

FIG. 3 is the flow chart of the hot galvanizing pickling waste liquor treatment process shown in FIG. 2.

FIG. 4a is the result graph of simulating 700 sampled test data with fault 1 after modeling by 5% labeled samples for one embodiment of the present invention.

FIG. 4b is the result graph of simulating 700 sampled test data with fault 1 after modeling by 10% labeled samples for one embodiment of the present invention.

FIG. 4c is the result graph of simulating 700 sampled test data with fault 1 after modeling by 15% labeled samples for one embodiment of the present invention.

FIG. 5a is the result graph of simulating 700 sampled test data with fault 2 after modeling by 5% labeled samples for one embodiment of the present invention.

FIG. 5b is the result graph of simulating 700 sampled test data with fault 2 after modeling by 10% labeled samples for one embodiment of the present invention.

FIG. 5c is the result graph of simulating 700 sampled test data with fault 2 after modeling by 15% labeled samples for one embodiment of the present invention.

FIG. 6a is the monitoring result graph of the influence of testing the regulation parameter γ=10⁻¹ on fault isolation performance for one embodiment of the present invention.

FIG. 6b is the monitoring result graph of the influence of testing the regulation parameter γ=10¹ on fault isolation performance for one embodiment of the present invention.

FIG. 6c is the monitoring result graph of the influence of testing the regulation parameter γ=10² on fault isolation performance for one embodiment of the present invention.

FIG. 6d is the monitoring result graph of the influence of testing the regulation parameter γ=10³ on fault isolation performance for one embodiment of the present invention.

FIG. 6e is the monitoring result graph of the influence of testing the regulation parameter γ=10⁴ on fault isolation performance for one embodiment of the present invention.

FIG. 6f is the monitoring result graph of the influence of testing the regulation parameter γ=10⁵ on fault isolation performance for one embodiment of the present invention.

### DETAILED DESCRIPTION OF THE PREFERRED EMBODIMENT

One embodiment of the present invention is detailed in combination with the figures.

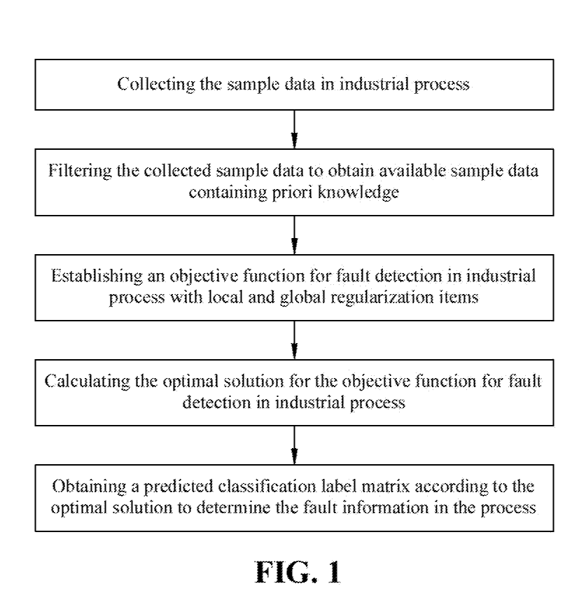

The fault isolation method of industrial process based on regularization framework provided by the embodiment, as shown in FIG. 1, includes the steps of:

step 1: collecting the sample data in industrial process;

step 2: filtering the collected sample data to remove singular sample data and retain available sample data; wherein the available sample data includes labeled sample data and unlabeled sample data; the labeled sample data is used by experienced experts or workers to differentiate the characteristics of the collected data and respectively label the collected data as normal sample data, fault sample data and categories of their corresponding fault states to enable these sample data to have classification labels; the unlabeled data is the data which is directly collected but not labeled and belongs to the sample data of the classification label to be predicted, wherein the available sample data set is expressed as:

T=={(x₁,y₁), . . . (xₗ,yₗ)}∪{xₗ₊₁, . . . xₙ}; xⱼ∈R^{d}, j=1, . . . ,n (1)

wherein d is the number of variables; n is the number of samples; xᵢ|ᵢ₌₁^{l} is the labeled sample data, and xᵢ|ᵢ₌ₗ₊₁ⁿ is the unlabeled data; yᵢ∈{1, 2, . . . , c}, i=1, . . . , l, wherein c is the category of the fault state, and l is the number of the labeled samples;

step 3: establishing an objective function for fault isolation in industrial process,

$$J ( F ) = {min}_{F ∈ {•}^{n \times c}} tr ( {( F - Y )}^{T} D ( F - Y ) + \frac{γ}{{n}^{2}} {F}^{T} GF + {F}^{T} MF ) \qquad ( 2 )$$

wherein F is a predicted classification label matrix; tr is the trace symbol of the matrix; D is a diagonal matrix, wherein the diagonal elements are Dᵢᵢ=Dₗ>0, i=−1, . . . , l, Dᵢᵢ=Dᵤ≧0, and i=l+1, . . . , n, and the concrete values of Dₗ and Dᵤ are selected artificially based on the experience; (F−Y)^{T}D(F−Y) is empirical loss used to measure the difference value between predicted classification label and initial classification label; γ is a regulation parameter to be determined by test;

$$\frac{γ}{{n}^{2}} {F}^{T} GF$$

is a global regularization item, and G is a global regularization matrix; F^{T}MF is a local regularization item, and M is a local regularization matrix; Y∈R^{n×c} is an initial classification label matrix, and the elements of Y are defined as follows:

$${Y}_{ij} = \{ \begin{matrix}1 , if {x}_{i} is labeled as category j fault state , \\ j is one of category c fault states \\ 0 , otherwise\end{matrix} \qquad ( 3 )$$

step 4: calculating the optimal solution for the objective function for fault isolation in industrial process by the available sample data set;

step 4.1: obtaining a global regularization matrix G according to the improved similarity measurement algorithm and KNN (k-Nearest Neighbor) classification algorithm,

wherein in the fault isolation process, labeled sample data is only in the minority, and sufficient fault isolation precision cannot be ensured by the unconstrained optimization problem of the minimization standard framework, so some labeled samples are required to direct the solving of F. The global regularization item ∥f∥_{I}² reflects the inherent geometric distribution information of p(x). p(x) is the distribution probability of samples, p(y|x) is the conditional probability with the classification label of y under the condition that the sample x is known, and samples distributed more intensively are most likely to have similar classification labels, that is if x₁ and x₂ are adjacent, p(y|x₁)≈p(y|x₂), x₁ and x₂ have similar classification labels. In other words, p(y|x) shall be very smooth under geometric properties within p(x). ∥f∥_{I}² is a Riemann integral with the form as follows:

$${‖ f ‖}_{I}^{2} = {\int }_{x ∈ M}^{ } {‖ {∇}_{M} f ‖}^{2} d p ( x )$$

wherein f is a real-valued function; M represents low-dimensional data manifold, ∇_{M}f is the gradient of f to M, and ∥f∥_{I}² reflects the smoothness of f. ∥f∥_{I}² can be further approximately expressed as:

$${‖ f ‖}_{I}^{2} = \frac{γ}{{n}^{2}} {F}^{T} GF$$

wherein G can be calculated by Formula (5),

G=S−W∈R^{n×n} (5)

wherein Formula (5) is further improved by a regularized Laplacian matrix to obtain Formula (6):

$$G = I - {S}^{- \frac{1}{2}} {WS}^{- \frac{1}{2}} ∈ {R}^{n \times n} \qquad ( 6 )$$

wherein I is the unit matrix of k×k; S is a diagonal matrix, wherein the diagonal elements are

$${S}_{ii} = {\sum }_{j = 1}^{n} {W}_{ij} ,$$

i=1, 2, . . . m n; W∈R^{n×n}, and is a similarity matrix; W and the sample point xᵢ|ᵢ₌₁ⁿ form an undirected weighted graph with the vertex corresponding to the sample point and the edge Wᵢⱼ corresponding to the similarity of the sample points xᵢ|ᵢ₌₁ⁿ and xⱼ|ⱼ₌₁ⁿ the precision of the final fault classification is determined by the calculation method of W, W is calculated by the method of local reconstruction using neighbor points of the sample point xᵢ, and the reconstruction error equation is as follows:

$${\sum }_{i = 1}^{n} {‖ {x}_{i} - {\sum }_{j = 1}^{k} {W}_{ij} {x}_{ij} ‖}^{2} \qquad ( 7 )$$

wherein

$${\sum }_{i = 1}^{k} {W}_{ij} = 1 ,$$

and the minimum value of Formula (7) is calculated to get W and then G by Formula (5); the specific steps for calculating W are as follows:

step 4.1.1: obtaining the distance measurement between xᵢ and its k neighbor points by the improved distance formula (8) to calculate the distance between sample points, i.e., sample similarity measurement;

$${W}_{ij} = d ( {x}_{i} , {x}_{j} ) = \frac{‖ {x}_{i} - {x}_{j} ‖}{\sqrt{M ( i ) M ( j )}} \qquad ( 8 )$$

M(i) and M(j) respectively represent the average value of distances between the sample point xᵢ and its k neighbors and the average value of distances between the sample point xⱼ and its k neighbors;

step 4.1.2: converting Formula (8) to Formula (9) through kernel mapping;

$$d ( {x}_{i} , {x}_{j} ) = \frac{\sqrt{{K}_{ii} - 2 {K}_{ij} + {K}_{jj}}}{\sqrt{Δ}} \qquad ( 9 )$$

wherein Kᵢⱼ=Φ(xᵢ)^{T}Φ(xⱼ), Kᵢᵢ=Φ(xᵢ)^{T}Φ(xᵢ), Kⱼⱼ=Φ(xⱼ)^{T}Φ(xⱼ), and K is Mercer kernel; the numerator \sqrt{Kᵢᵢ−2Kᵢⱼ+Kⱼⱼ} of Formula (9) is obtained by deducing the numerator ∥xᵢ−xⱼ∥ of Formula (8) through kernel mapping, i.e., ∥Φ(xᵢ)−Φ(xⱼ)∥=\sqrt{∥Φ(xᵢ)−Φ(xⱼ)∥²}=\sqrt{Kᵢᵢ−2Kᵢⱼ+Kⱼⱼ}; in the denominator of Formula (9),

$$Δ = \frac{\begin{matrix}{\sum }_{p = 1}^{k} ( {K}_{ii} - {K}_{{ii}^{p}} - {K}_{{i}^{{p}_{i}}} + {K}_{{i}^{p} {i}^{p}} ) \\ {\sum }_{q = 1}^{k} ( {K}_{jj} - {K}_{{jj}^{p}} - {K}_{{j}^{p} j} + {K}_{{j}^{p} {j}^{p}} )\end{matrix}}{{k}^{2}}$$

which is obtained by deducing the denominator of Formula (8) through kernel mapping, and the specific deducing process is as follows: given that

$$M ( i ) = \frac{1}{k} ( {\sum }_{p = 1}^{k} ‖ {x}_{i} - {x}_{i}^{p} ‖ ) and M ( j ) = \frac{1}{k} ( {\sum }_{q = 1}^{k} ‖ {x}_{j} - {x}_{j}^{q} ‖ ) ,$$

the following Formula can be obtained:

$$M ( i ) M ( j ) = [ \frac{1}{k} ( {\sum }_{p = 1}^{k} ‖ {x}_{i} - {x}_{i}^{p} ‖ ) ] [ \frac{1}{k} ( {\sum }_{q = 1}^{k} ‖ {x}_{j} - {x}_{j}^{q} ‖ ) ] = \frac{{\sum }_{p = 1}^{k} [ {( {x}_{i} - {x}_{i}^{p} )}^{T} ( {x}_{i} - {x}_{i}^{p} ) ] {\sum }_{q = 1}^{k} {[ {x}_{j} - {x}_{j}^{q} )}^{T} ( {x}_{j} - {x}_{j}^{q} ) ]}{{k}^{2}} {}^{kernelized} \frac{{\sum }_{p = 1}^{k} ( {K}_{ii} - {K}_{{ii}^{p}} - {K}_{{i}^{p} i} + {K}_{{i}^{p} {i}^{p}} ) {\sum }_{q = 1}^{k} ( {K}_{jj} - {K}_{{jj}^{p}} - {K}_{{j}^{p} j} + {K}_{{j}^{p} {j}^{p}} )}{{k}^{2}} = Δ$$

wherein Kᵢᵢ_{^{p}}=Φ(xᵢ)^{T}Φ(xᵢ^{p}); Kᵢ_{^{p}}ᵢ=Φ(xᵢ^{p})^{T}Φ(xᵢ); Kᵢ_{^{p}}ᵢ_{^{p}}=Φ(xᵢ^{p})^{T}Φ(xᵢ^{p}); Kⱼⱼ_{^{q}}=Φ(xⱼ)^{T}Φ(xⱼ^{q}); Kⱼ_{^{q}}ⱼ=Φ(xⱼ^{q})^{T}Φ(xⱼ); Kⱼ_{^{q}}ⱼ_{^{q}}=Φ(xⱼ^{q})^{T}Φ(xⱼ^{q}); xᵢ^{p} (p=1, 2 . . . k) is the p th neighbor point of xᵢ; xⱼ^{q} (q=1, 2 . . . k) is the q th neighbor point of xⱼ;

step 4.1.3: defining the sample similarity measurement, i.e., distance measurement between samples, by Formula (9) according to the labeled data and the unlabeled data among the collected data, expressed by Formula (10):

$$d ( {x}_{i} , {x}_{j} ) = \{ \begin{matrix}\sqrt{1 - exp ( \frac{{‖ {x}_{i} - {x}_{j} ‖}^{2}}{β} )} - α , when {x}_{i} and {x}_{j} are labeled identically \\ \begin{matrix}\sqrt{1 - exp ( \frac{{‖ {x}_{i} - {x}_{j} ‖}^{2}}{β} )} when {x}_{i} and {x}_{j} are u nlabeled , \\ {x}_{j} ∈ {N}_{i} or {x}_{i} ∈ {N}_{j}\end{matrix} \\ \sqrt{exp ( - \frac{{‖ {x}_{i} - {x}_{j} ‖}^{2}}{β} )} , otherwise \end{matrix} \qquad ( 10 )$$

wherein β is a control parameter depending on the distribution density of the collected sample data points; α is a regulation parameter;

step 4.1.4: getting k neighbors of the sample xᵢ by the distance measurement defined in Formula (10) to obtain the neighbor domain Nᵢ of xᵢ;

step 4.1.5: reconstructing xᵢ by k neighbor points of the sample xᵢ to calculate the minimum value of xᵢ reconstruction error, i.e., the optimal similarity matrix W:

$$arg m in {\sum }_{i = 1}^{n} {‖ Φ ( {x}_{i} ) - {\sum }_{{x}_{j} ∈ {N}_{i}} {W}_{ij} Φ ( {x}_{j} ) ‖}^{2} \qquad ( 11 )$$

wherein Formula (7) is converted to Formula (11) through kernel mapping of sample points; ∥•∥ is an Euclidean norm; Wᵢⱼ has two constraint conditions:

$${\sum }_{{x}_{j} ∈ {N}_{i}} {W}_{ij} = 1 ,$$

and Wᵢⱼ=0 when xⱼ∉Nᵢ;

step 4.2: obtaining a local regularization matrix M;

step 4.2.1: determining k neighbor points of the sample point xᵢ through Euclidean distance, and defining the set of the k neighbor points, i.e., the neighbor domain of xᵢ is Nᵢ={xᵢ_{ⱼ}}ⱼ₌₁^{k}, wherein xᵢ represents the j th neighbor point of the sample point xᵢ;

step 4.2.2: establishing a loss function expressed by Formula (13) to cause sample classification labels to be distributed smoothly,

$$J ( {g}_{i} ) = {\sum }_{j = 1}^{k} {( {f}_{{i}_{j}} - {g}_{i} ( {x}_{{i}_{j}} ) )}^{2} + λ S ( {g}_{i} ) \qquad ( 13 )$$

wherein the first item

$${\sum }_{j = 1}^{k} {( {f}_{{i}_{j}} - {g}_{i} ( {x}_{{i}_{j}} ) )}^{2}$$

is the sum of errors of the predicted classification labels and actual classification labels of all samples; λ is a regulation parameter; the second item S(gᵢ) is a penalty function; the function gᵢ:R^{m}→R, and

$${g}_{i} ( x ) = {\sum }_{j = 1}^{d} {β}_{i , j} {p}_{j} ( x ) + {\sum }_{j = 1}^{k} {α}_{i , j} {Φ}_{i , j} ( x ) ,$$

which enable each sample point to reach a classification label through the mapping:

fᵢ_{ⱼ}=gᵢ(xᵢ_{ⱼ}), j=1,2, . . . ,k (14)

wherein fᵢ_{ⱼ} is the classification label of the j th neighbor point of the sample point xᵢ;

$$d = \frac{( m + s - l ) !}{m ! ( s - l ) !} ,$$

m is the dimension of x, and s is the partial derivative order of semi-norm; {pⱼ(x)}ᵢ₌₁^{d} constitutes polynomial space with the order not less than s, and 2s>m; φ_{i,j}(x) is a Green function; β_{i,j} and φ_{i,j} are two coefficients the Green function;

step 4.2.3: obtaining the estimated classification label loss of the set Nᵢ of neighbor points of the sample point xᵢ by calculating the minimum value of the loss function established in step 4.2.2;

For k dispersed sample data points, the minimum value of the loss function J(gᵢ(x)) can be estimated by Formula (15),

$$J ( {g}_{i} ) \approx {\sum }_{j = 1}^{k} {( {f}_{{i}_{j}} - {g}_{i} ( {x}_{{i}_{j}} ) )}^{2} + {λα}_{i}^{T} {H}_{i} {α}_{i} \qquad ( 15 )$$

wherein Hᵢ is the symmetric matrix of k×k, and its (r,z) elements are K_{r,z}=φ_{i,z}(xᵢ_{ᵣ}), αᵢ=[α_{i,1}, α_{i,2}, . . . , α_{i,k}]∈R^{k} and βᵢ=[β_{i,1}, β_{i,2}, . . . , β_{i,d-1}]^{T}∈R^{k};
For a smaller λ (for example, λ=0.0001), the minimum value of the loss function J(gᵢ(x)) can be estimated by the classification label matrix to obtain the estimated classification label loss of the set Nᵢ of neighbor points of the sample point xᵢ:

J(gᵢ)≈λFᵢ^{T}MᵢFᵢ (16)

wherein Fᵢ=[fᵢ_{₁}, fᵢ_{₂}, . . . , fᵢ_{ₖ}]∈R^{k} corresponds to the classification labels of k data in Nᵢ; Mᵢ is the upper left k×k subblock matrix of the inverse matrix of the coefficient matrix and is calculated by Formula (17):

αᵢ^{T}(Hᵢ+λI)αᵢ=Fᵢ^{T}MᵢFᵢ (17)

step 4.2.4: collecting the estimated classification label losses of the neighbor domains {Nᵢ}ᵢ₌₁ⁿ of n sample points together to obtain the total estimated classification label loss, which is expressed by Formula (18), and calculating the minimum value of the total loss E(f), i.e., the classification label of the sample data, so as to obtain the local regularization matrix M; the total estimated classification label loss is expressed by Formula (18),

$$E ( f ) \approx λ {\sum }_{i = 1}^{n} {F}_{i}^{T} {M}_{i} {F}_{i} \qquad ( 18 )$$

wherein f=[f₁, f₂, . . . , fₙ]^{T}∈Rⁿ is the vector of the classification label, wherein when the coefficient λ in Formula (18) is neglected, Formula (18) is converted to Formula (19):

$$E ( f ) ∝ {\sum }_{i = 1}^{n} {F}_{i}^{T} {M}_{i} {F}_{i} \qquad ( 19 )$$

wherein according to the row selection matrix Sᵢ∈R^{k×n}, Fᵢ=Sᵢf; wherein the elements Sᵢ(u,v) in the u th row and the v th column of Sᵢ can be defined by Formula (20):

$${S}_{i} ( u , v ) = \{ \begin{matrix}1 , & if v = {i}_{u} \\ 0 , & else\end{matrix} \qquad ( 20 )$$

wherein Fᵢ=Sᵢf is substituted into Formula (20) to obtain E(f)∝f^{T}Mf, wherein

$$M = {\sum }_{i = 1}^{n} {S}_{i}^{T} {M}_{i} {S}_{i} ;$$

step 4.3: obtaining the optimal solution F* of the objective function by making the partial derivative of the objective function J(F) for fault isolation in industrial process;

$$\begin{matrix}\frac{\partial J}{\partial F} F = {F}^{*} = 2 D ( {F}^{*} - Y ) + 2 \frac{γ}{{n}^{2}} {GF}^{*} + 2 MF = 0 \\ ⇒ ( D + \frac{γ}{{n}^{2}} G + M ) {F}^{*} = DY \\ ⇒ {F}^{*} = {( D + \frac{γ}{{n}^{2}} G + M )}^{- 1} DY\end{matrix} \qquad ( 12 )$$

step 5: obtaining the predicted classification label matrix by Formula (4) according to the optimal solution F* to determine the fault information in the process.

$${f}_{i} = {argmax}_{1 \leq j \leq c} {F}_{ij}^{*} \qquad ( 4 )$$

wherein fᵢ is the predicted classification label of the sample point xᵢ.

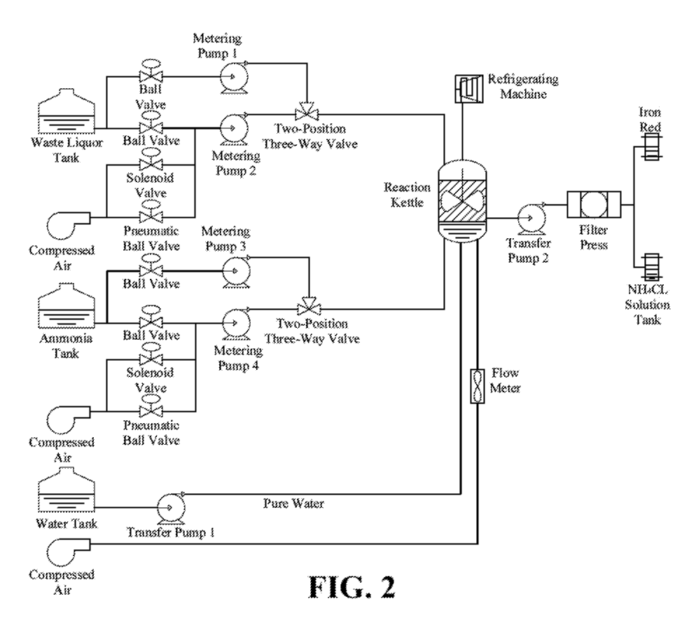

To verify the effectiveness of the fault isolation method of industrial process based on regularization framework provided by the embodiment in isolating faults in industrial process with various fault types, the experiment platform shown in FIG. 2 is used to conduct simulation experiment.

The experiment platform shown in FIG. 2 is the hot galvanizing pickling waste liquor treatment process. During hot galvanizing production, iron and steel workpieces are firstly degreased by alkali solution and then etched by hydrochloric acid to remove rust and oxide film from the surfaces of the iron workpieces.

Iron and steel react with hydrochloric acid to produce the following ferric salts:

FeO+2HCl→FeCl₂+H₂O Fe₂O₃+6HCl→2FeCl₃+3H₂O

5FeO+O₂+14HCl→4FeCl₃+FeCl₂+7H₂O Fe+2HCl→FeCl₂+H₂↑

The reaction shows that when iron and steel are pickled in hydrochloric acid, two ferric salts are produced: ferric chloride and ferrous chloride. In general condition, there are less pickling pieces terribly rusty, so most of the products are ferrous chloride. As ferric salts increase, the concentration of the hydrochloric acid becomes lower, which is commonly referred to as failure. The usual method is to discard the hydrochloric acid near failure, but this method is no longer used due to awareness enhancement and control of environmental protection and development of recovery technology. In fact, the waste acid sometimes has high concentration, and the discarded acid solution may contain more acid than that taken out during usual cleaning after pickling. Therefore, this is an important pollution source and also a waste of resources. The best method is to recycle acid solution.

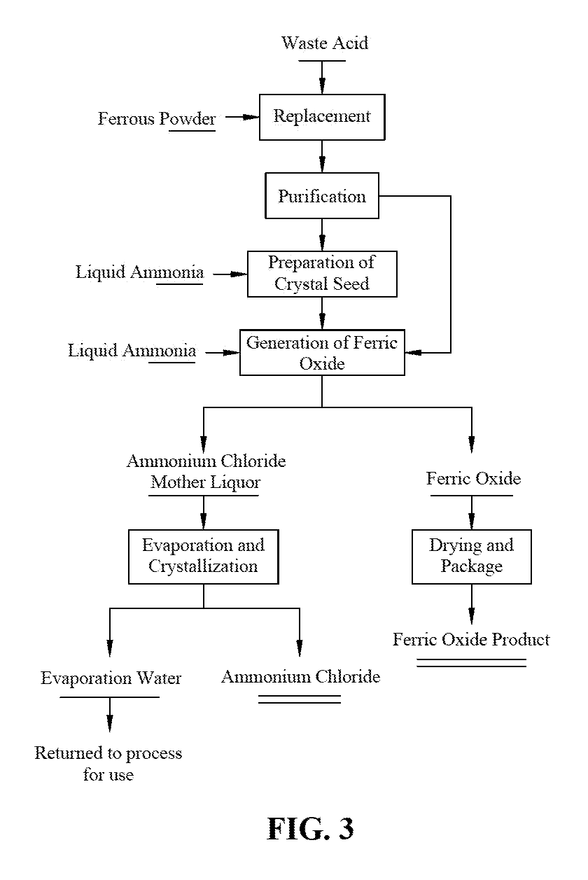

During hot galvanizing production of the embodiment, the technological process for pickling waste acid is shown in FIG. 3 as follows: waste acid produced during pickling in a hot galvanizing plant is input into a waste liquor tank with a stirrer, excessive ferrous powder is added to replace ferric iron into ferrous iron, and then the replaced solution is further purified through solid-liquid separation to obtain waste acid solution with ferrous chloride as the major ingredient; an appropriate amount of ferrous chloride solution is input into a reaction kettle, and iron red (or iron yellow) crystal seed is prepared by regulating certain temperature, pH value, concentration, air input and stirring rate and controlling the time; crystal seed is condensation nuclei; ferrous chloride waste acid solution is transferred to generate iron red (or iron yellow) through oxidation by regulating temperature, pH value, concentration, air input and stirring rate and controlling the time; the generated iron red (or iron yellow) solution is treated through solid-liquid separation, solid powder is dried and then packaged into products, ammonium chloride mother liquor in the liquid can be prepared into ammonium chloride by-products through evaporation and crystallization, and evaporation condensate water is returned to the system for use.

According to the above introduction and research on chemical and physical changes, the experiment platform is mainly composed of a waste liquor tank, a reaction kettle (overall reaction system), a filter pressing device, a pipeline valve, pumps, a control system, a distribution box, an electric control cabinet, a power supply cabinet, an air compressor, etc. Variables of the whole system include: temperature, pressure and liquid level in the reaction kettle, flow entering the reaction kettle, current of the transfer pump 1, current of the transfer pump 2, speed and current of the metering pump 1, speed and current of the metering pump 2, speed and current of the metering pump 3, speed and current of the metering pump 4, and current, voltage and speed of the stirrer in the reaction kettle. The faults and fault types of the hot galvanizing pickling waste liquor treatment process shown by the experiment platform are shown in Table 1.

TABLE 1
Fault Description (Feature) of Hot Galvanizing
Pickling Waste Liquor Treatment Process

| Fault Name | Fault Type |
|---|---|
| Fault 1: Transfer pump 1 suddenly stalls due to fault | Step |
| Fault 2: Pipeline control valve fails | Step |

It is extremely difficult to obtain labeled sample data during actual industrial process, so a small amount of such data is selected in the embodiment as training data which includes three states: normal, fault 1 and fault 2.

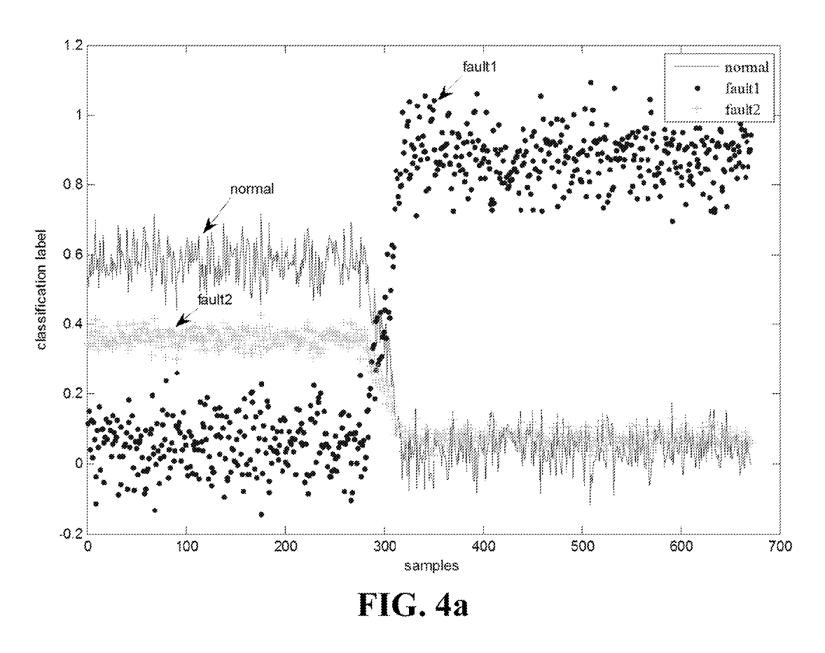

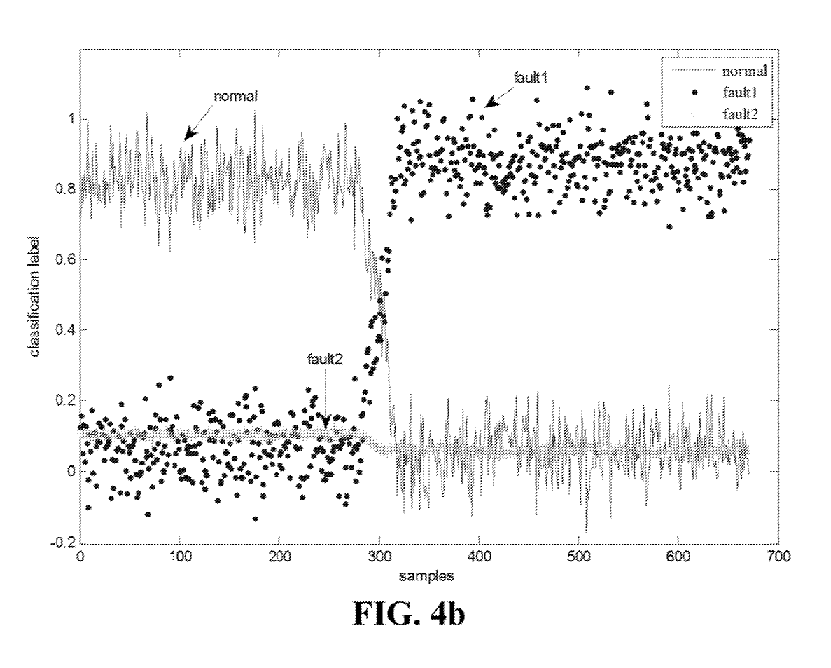

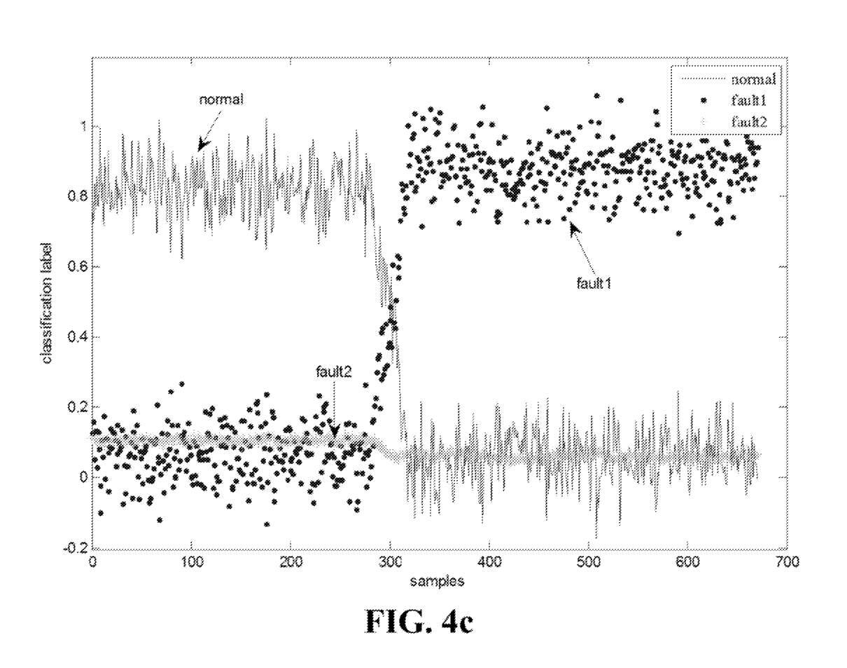

In the embodiment, the first set of 700 sampled data with fault 1 is firstly simulated. This set of test samples mainly includes normal data and data with fault 1, which is specifically embodied in that the first 300 sample points operate normally and then fault 1 occurs. To determine the influence of different numbers of labeled data samples on monitoring results, 5% labeled samples, 10% labeled samples and 15% labeled samples are respectively selected by the embodiment for modeling and then the process monitoring results are observed. As shown in FIG. 4a, FIG. 4b and FIG. 4c, it can be found that for the model, normal characteristics can be extracted from the first 300 data, and then the characteristics of fault 1 can be extracted from the remaining 400 data, so it can be determined that the fault in the test sample occurs at the 300th sample point. During modeling, different numbers of labeled data samples and their corresponding different monitoring results are shown successively in FIG. 4a, FIG. 4b and FIG. 4c.

It can be seen from FIG. 4a that under normal condition, the maximum category difference is approximately equal to 0.6, and although the category differentiation is not high, three types of characteristics can be respectively extracted without overlap. The category difference is approximately equal to 1 in case of a fault. Although the category differentiation is very high, and fault 1 can be isolated, the characteristics of the normal data and the characteristics of fault 2 have very low differentiation and have large overlap. As a whole, the sample point where a fault occurs can be found exactly by this set of experiments.

It can be seen from FIG. 4b that under normal condition, the maximum category difference is approximately equal to 0.7, and although the category differentiation is not high, only normal characteristics can be extracted, and fault 1 and fault 2 have serious overlap. The category difference is approximately equal to 0.9 in case of a fault. Although the category differentiation is very high, and fault 1 can be isolated, the characteristics of the normal data and the characteristics of fault 2 have very low differentiation and have large overlap. As a whole, the sample point where a fault occurs can be found exactly by this set of experiments.

It can be seen from FIG. 4c that under normal condition, the maximum category difference is approximately equal to 0.7, and although the category differentiation is not high, only normal characteristics can be extracted, and fault 1 and fault 2 have serious overlap. The category difference is approximately equal to 0.9 in case of a fault. Although the category differentiation is very high, and fault 1 can be isolated, the characteristics of the normal data and the characteristics of fault 2 have very low differentiation and have large overlap. As a whole, the sample point where a fault occurs can be found exactly by this set of experiments.

As shown in FIG. 4a, FIG. 4b and FIG. 4c, it can be found that for the model, normal characteristics can be extracted from the first 300 data of the test sample, and then the characteristics of fault 1 can be extracted from the remaining 400 data, so it can be determined that the fault in the test sample occurs at the 300th sample point. However, as the number of the labeled sample data among the training data increases, the direction information increases, which is good for category determination of unlabeled data. The category differentiation is increasing gradually, i.e., the fault isolation effect is better, and the influence of interference is less. The results shown in FIG. 4b and FIG. 4c are basically consistent, and it can be found that when the training data includes two labeled samples, the fault isolation performance has basically become saturated, showing that when the labeled samples achieve a certain quantity, the increase in the category differentiation becomes slower even stable.

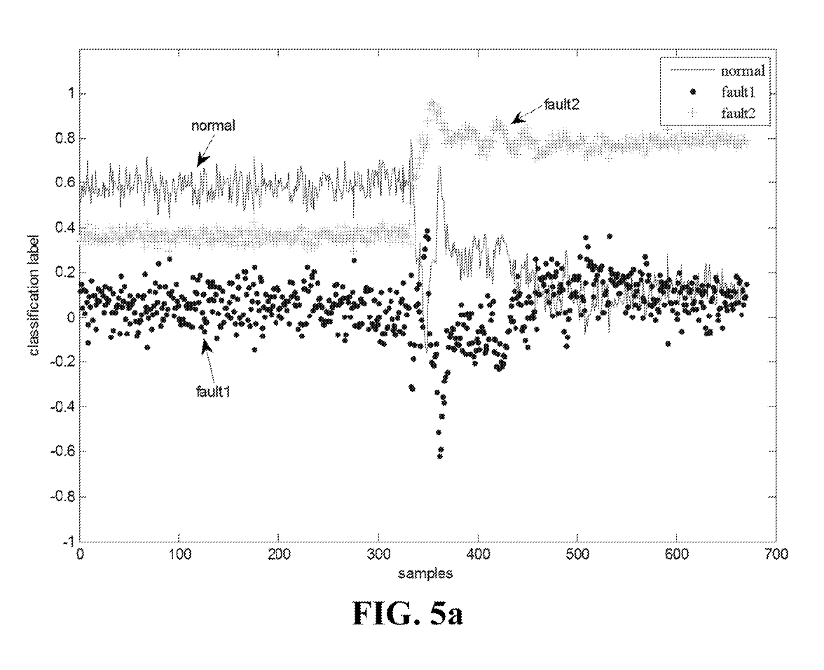

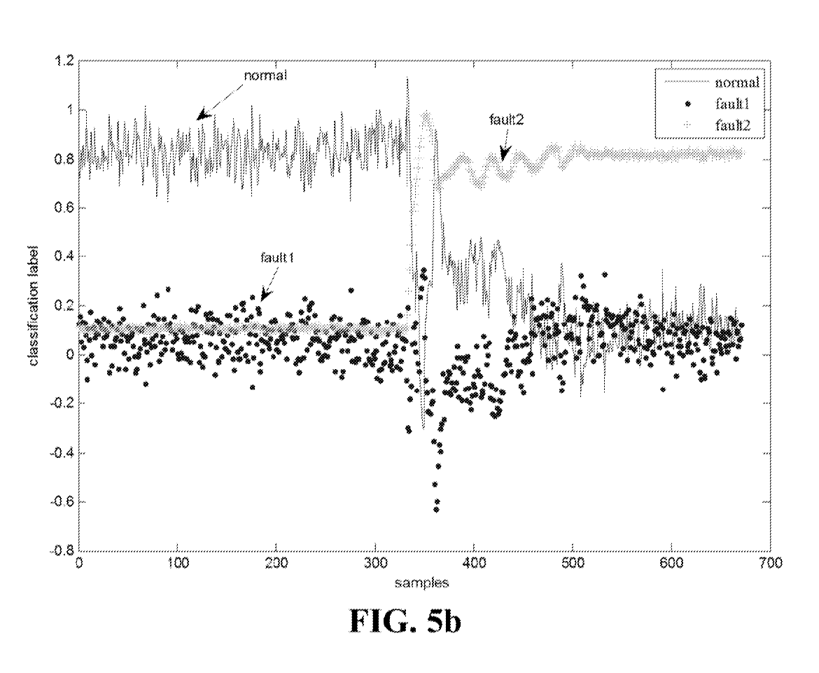

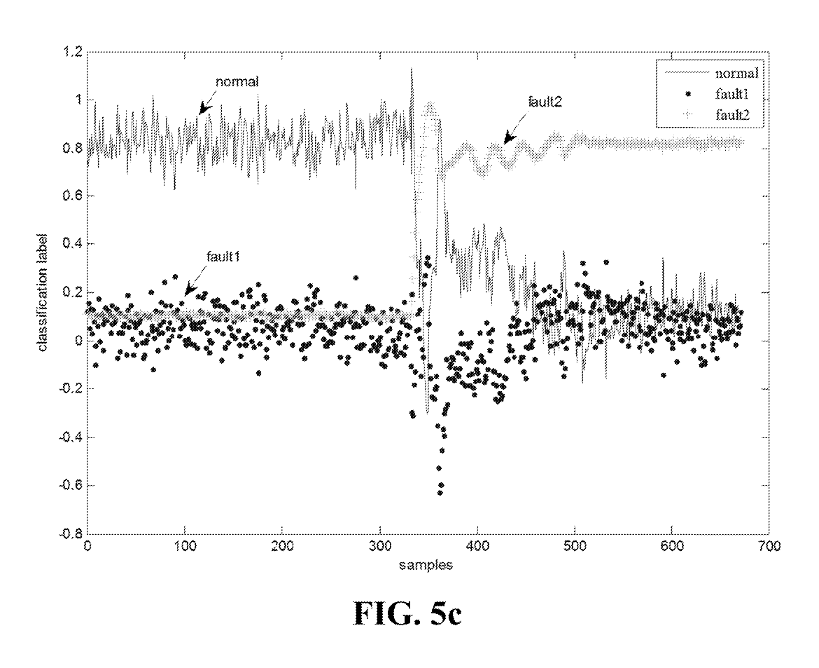

In the embodiment, the second set of 700 sampled data with fault 2 is then simulated. This set of test samples mainly includes normal data and data with fault 2, which is specifically embodied in that the first 350 sample points operate normally and then fault 2 occurs. To determine the influence of different numbers of labeled data samples on monitoring results, training data with 5% labeled samples, training data with 10% labeled samples and training data with 15% labeled samples are respectively selected by the embodiment for modeling, and then the process monitoring results are observed, as shown in FIG. 5a, FIG. 5b and FIG. 5c. It can be found that normal characteristics can be extracted from the first 350 data of the test sample, and then the characteristics of fault 2 can be extracted from the remaining 350 data, so it can be determined that the fault in the test sample occurs at the 350th sample point. During modeling, different numbers of labeled data samples and their corresponding different monitoring results are shown successively in FIG. 5a, FIG. 5b and FIG. 5c.

It can be seen from FIG. 5a that under normal condition, the maximum category difference is approximately equal to 0.5, and although the category differentiation is not high, three types of characteristics can be respectively extracted without overlap. The maximum category difference is approximately equal to 0.8 in case of a fault. Although the category differentiation is very high, and fault 2 can be isolated, the characteristics of the normal data and the characteristics of fault 1 have very low differentiation and have large overlap. In case of a fault, these characteristic curves fluctuate obviously and are vulnerable to interference. But when the 350th sample point is the turning point, the turning slope is larger. As a whole, the sample point wherein a fault occurs can be found exactly by this set of experiments.

It can be seen from FIG. 5b that under normal condition, the maximum category difference is approximately equal to 0.8, and although the category differentiation is not high, only normal characteristics can be extracted, and fault 1 and fault 2 have serious overlap. The maximum category difference is approximately equal to 0.8 in case of a fault. Although the category differentiation is very high, and fault 2 can be isolated, the characteristics of the normal data and the characteristics of fault 1 have very low differentiation and have large overlap. In case of a fault, these characteristic curves fluctuate obviously and are vulnerable to interference. But when the 350th sample point is the turning point, the turning slope is larger. As a whole, the sample point where a fault occurs can be found exactly by this set of experiments.

It can be seen from FIG. 5c that the diagnosis effect is basically consistent with that shown in FIG. 5b; under normal condition, the maximum category difference is approximately equal to 0.8, and although the category differentiation is not high, only normal characteristics can be extracted, and fault 1 and fault 2 have serious overlap. The maximum category difference is approximately equal to 0.8 in case of a fault. Although the category differentiation is very high, and fault 2 can be isolated, the characteristics of the normal data and the characteristics of fault 1 have very low differentiation and have large overlap.

As shown in FIG. 5a, FIG. 5b and FIG. 5c, it can be found that for the model, normal characteristics can be extracted from the first 350 data of the test sample, and then the characteristics of fault 2 can be extracted from the remaining 350 data, so it can be determined that the fault in the test sample occurs at the 350th sample point. However, as the number of the labeled samples among the training data increases, the direction information increases, which is good for category determination of unlabeled data. The category differentiation is increasing gradually, i.e., the fault isolation effect is better, and the influence of interference is less. The results shown in FIG. 5b and FIG. 5c are basically consistent, and it can be found that when the training data includes two labeled samples, the fault isolation performance has basically become saturated, showing that when the labeled samples achieve a certain quantity, the increase in the category differentiation becomes slower even stable.

The experiments show that modeling by using the training data with 10% labeled samples can obtain better fault monitoring effect, which just conforms to the characteristic that it is difficult to obtain many labeled samples in advance in fact. In fact, it is not easy to obtain fault information due to large harmfulness of faults, and the cost for labeling is high, so the known labeled data obtained in fact is less. The fault isolation method of industrial process based on regularization framework provided by the embodiment just can be used to obtain better fault isolation results through minimal labeled samples. Therefore, the fault isolation method of industrial process based on regularization framework provided by the embodiment is effective for process monitoring and fault isolation.

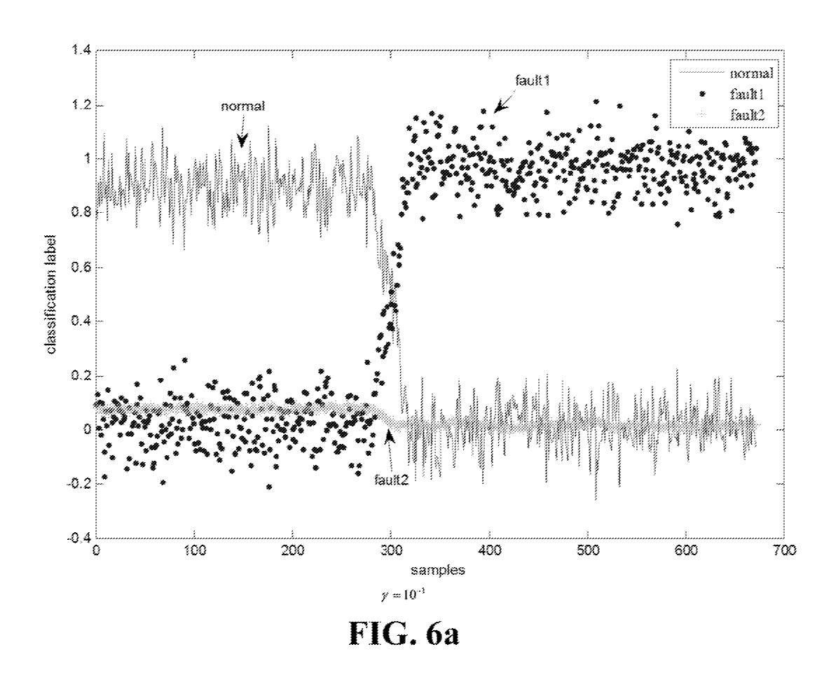

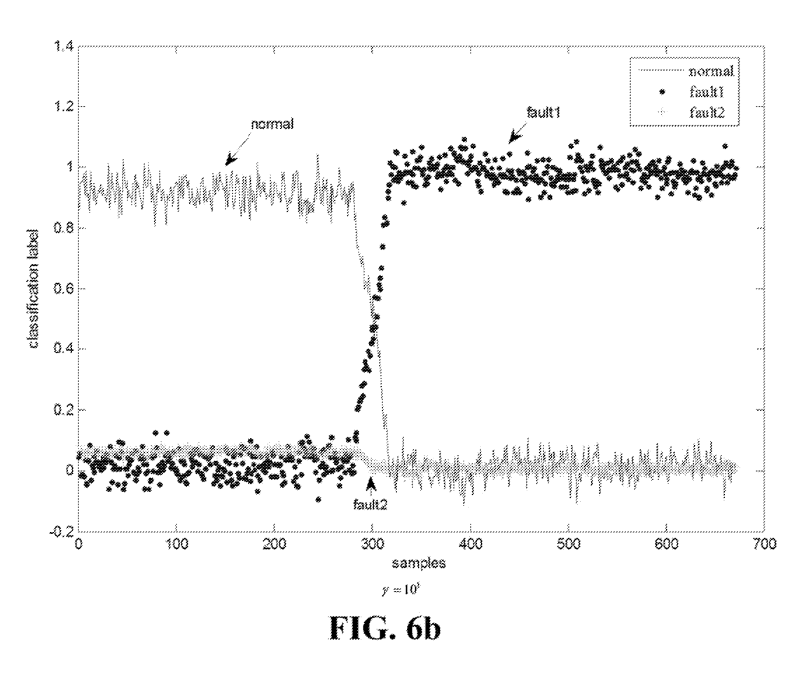

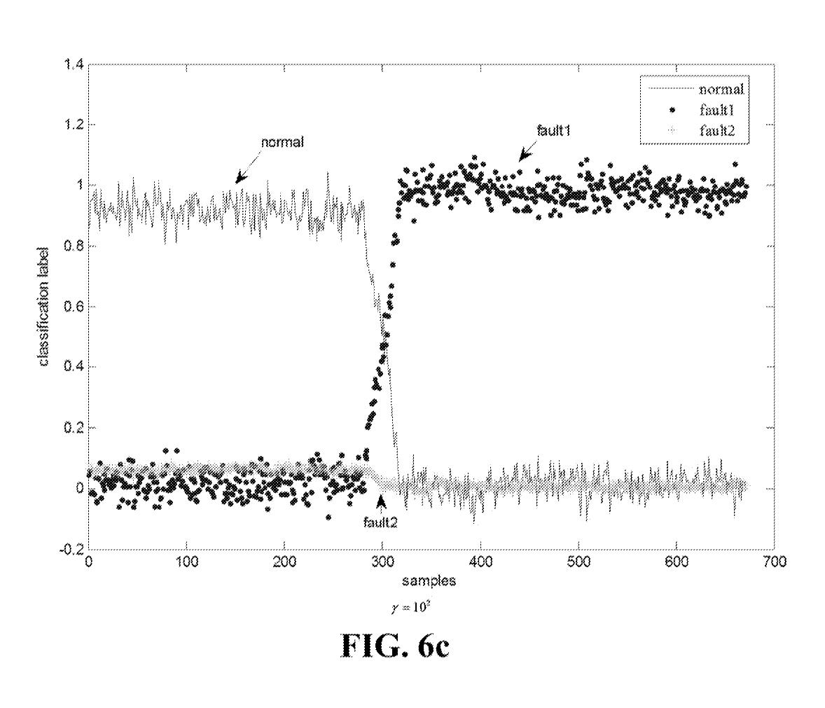

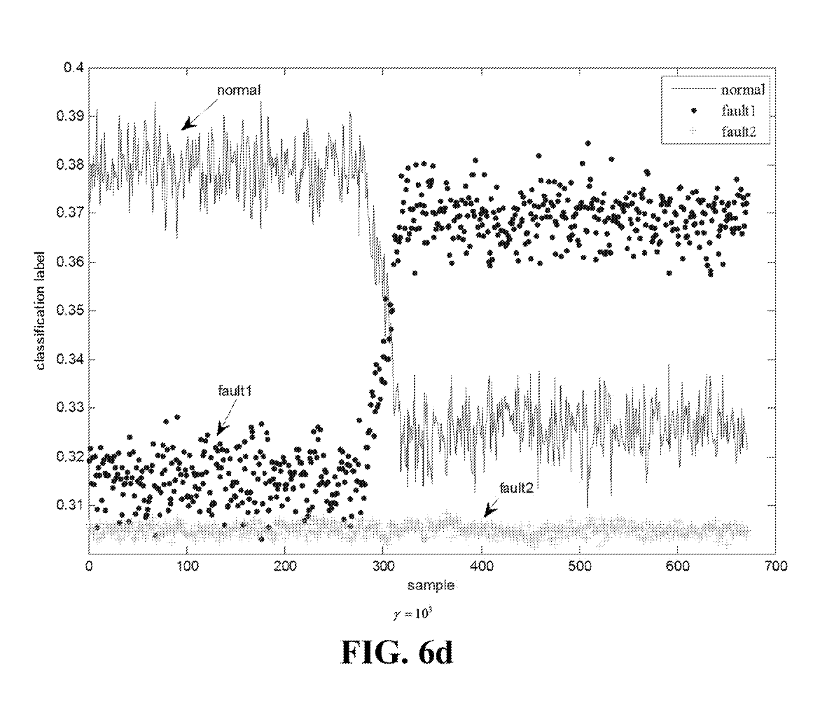

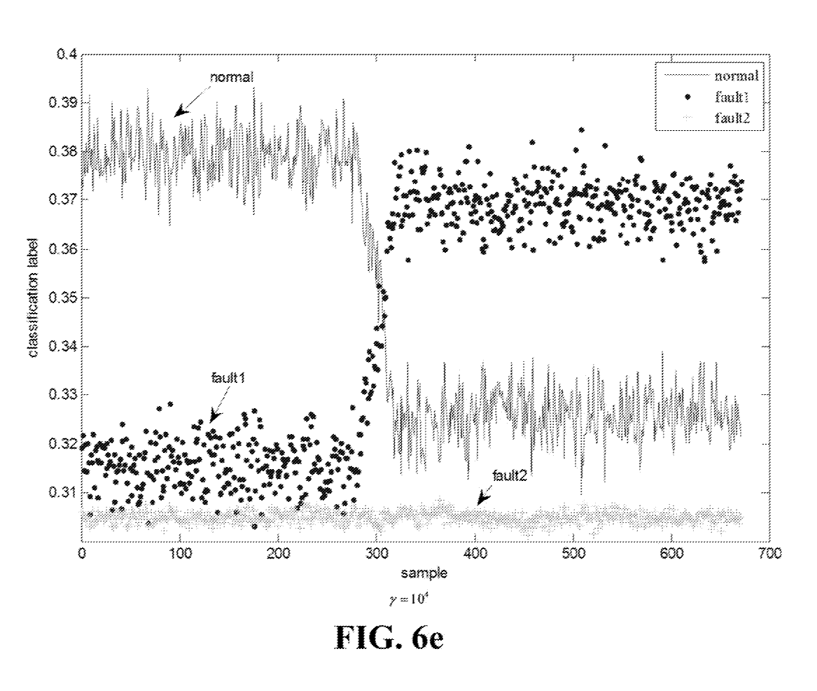

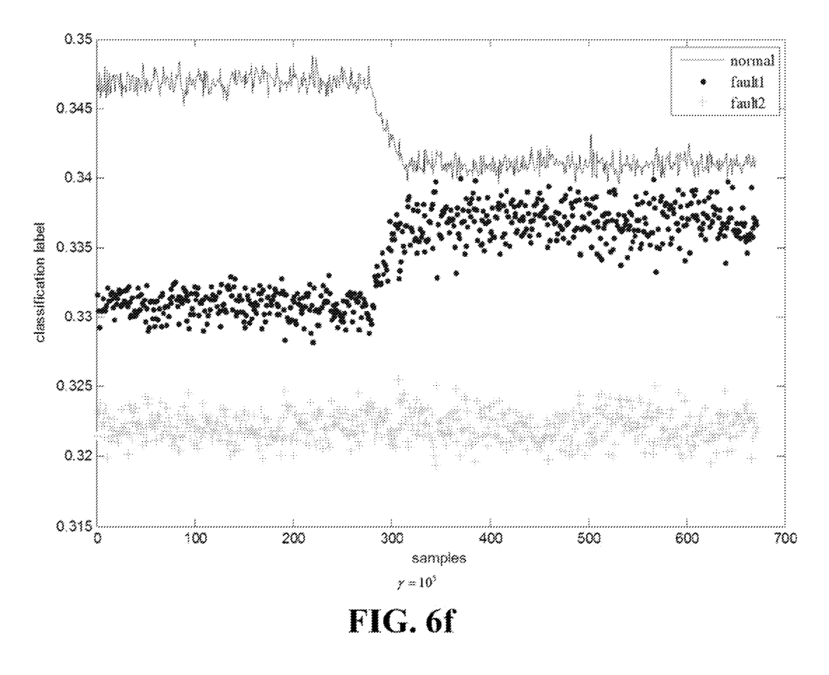

In the embodiment, the first set of test data with fault 1 and 10% labeled samples is then simulated, and used for observing the influence of the regulation parameter γ on the fault isolation performance to determine the optimal regulation parameter γ. This set of test samples mainly includes normal data and data with fault 1, which is still embodied in that the first 300 sample points operate normally and then fault 1 occurs. The monitoring results of the influence of the regulation parameter γ on the fault isolation performance are shown successively in FIG. 6a to FIG. 6f.

When γ=10⁻¹, it can be seen from FIG. 6a that the maximum category difference is approximately equal to 0.9 under normal condition, and the maximum category difference is approximately equal to 1 in case of a fault. The category differentiation is very high, but the shock is very violent and vulnerable to interference. Fault 1 can be monitored, but the characteristics of the normal data and the characteristics of fault 2 have very low differentiation and have large overlap. As a whole, the performance at this time is poor.

When γ=10¹ and γ=10², it can be seen from FIG. 6b and FIG. 6c that the maximum category difference is approximately equal to 0.9 under normal condition, the category differentiation is very high, and the shock is relatively less. The maximum category difference is approximately equal to 1 in case of a fault. The category differentiation is very high, and not only fault 1 can be monitored, but also these characteristic curves fluctuate less and are less vulnerable to interference. As a whole, the performance at this time is optimal.

When γ=10³ and γ=10⁴, it can be seen from FIG. 6d and FIG. 6e that the maximum category difference is approximately equal to 0.07 under normal condition, and the category differentiation is very low, which is not good for characteristic extraction. The maximum category difference is approximately equal to 0.07 in case of a fault. The category differentiation is very low, which is not good for characteristic extraction. The fault characteristics can be extracted, but the extraction is vulnerable to interference. As a whole, the performance at this time is poor.

When γ=10⁵, it can be seen from FIG. 6f that fault 1 occurring at the 300th sample point cannot be monitored at all, which may be caused by too small category difference, so the fault characteristics cannot be extracted, and the system cannot be applied at all at this time.

Conclusion: When 10¹<γ<10², the result with better effect can be obtained. However, when γ<10⁻¹, i.e., γ is too small, curves have better effect but violent shock and are vulnerable to interference. When 10³<γ<10⁴, i.e., γ is appropriately large, the category difference is small with less shock. When γ>10⁵, i.e., γ is too large, the category cannot be differentiated.

The fault isolation method of industrial process based on regularization framework provided by the embodiment uses the local regularization item to make the optimal solution have ideal nature, and uses the global regularization item to remedy the problem of insufficient fault isolation precision which may be caused by the local regularization item due to less samples in the neighbor domain so as to make the classification label smooth. Experiments show that the fault isolation method of industrial process based on regularization framework provided by the embodiment is not only feasible but also provides high fault isolation precision. In addition, it can be deduced by experiments that the fault isolation effect of the method depends on the proportion of the labeled sample and model parameters to a great extent.

What is claimed is:

1. A fault isolation method of industrial process based on regularization framework, comprising the steps of:
step 1: collecting sample data in industrial process;
step 2: filtering the collected sample data to remove singular sample data and retain available sample data, wherein the available sample data includes labeled sample data and unlabeled sample data, the labeled sample data is used by experienced experts or workers to differentiate the characteristics of the collected data and respectively label the collected data as normal sample data, fault sample data and categories of their corresponding fault states to enable these sample data to have classification labels; the unlabeled data is the data which is directly collected but not labeled and not having classification labels, wherein the available sample data set is expressed as:
T=={(x₁,y₁), . . . (xₗ,yₗ)}∪{xₗ₊₁, . . . xₙ}; xⱼ∈R^{d}, j=1, . . . ,n (1)
wherein d is the number of variables; n is the number of samples; xᵢ|ᵢ₌₁^{l} is the labeled sample data, and xᵢ|ᵢ₌ₗ₊₁ⁿ is the unlabeled data; yᵢ∈{1, 2, . . . , c}, i=1, . . . , l, wherein c is the category of the fault state, and l is the number of the labeled samples;
step 3: establishing an objective function for fault isolation in industrial process with local and global regularization items,
$$J ( F ) = {min}_{F ∈ {R}^{n \times c}} tr ( {( F - Y )}^{T} D ( F - Y ) + \frac{γ}{{n}^{2}} {F}^{T} GF + {F}^{T} MF ) \qquad ( 2 )$$
wherein J(F) is the objective function for fault isolation in industrial process; F is a predicted classification label matrix; tr is the trace symbol of the matrix; D is a diagonal matrix, wherein the diagonal elements are Dᵢᵢ=Dₗ>0, i=1, . . . , l, Dᵢᵢ=Dᵤ≧0, and i=l+1, . . . , n; (F−Y)^{T}D(F−Y) is empirical loss used to measure the difference value between predicted classification label and initial classification label; γ is a regulation parameter;
$$\frac{γ}{{n}^{2}} {F}^{T} GF$$
is a global regularization item, and G is a global regularization matrix; F^{T}MF is a local regularization item, and M is a local regularization matrix; Y∈R^{n×c} is an initial classification label matrix, and the elements of Y are defined as follows:
$${Y}_{ij} = \{ \begin{matrix}1 , & \begin{matrix}if {x}_{i} is labeled as category j fault state , \\ j is one of category c fault\end{matrix} \\ 0 , & otherwise\end{matrix} ; \qquad ( 3 )$$
step 4: calculating the optimal solution F* for the objective function for fault isolation in industrial process shown in Formula (2) by the available sample data set;
step 5: obtaining the predicted classification label matrix by Formula (4) according to the optimal solution F* to determine the fault information in the process,
$${f}_{i} = {argmax}_{1 \leq j \leq c} {F}_{ij}^{*} \qquad ( 4 )$$
wherein fᵢ is the predicted classification label of the sample point xᵢ.

2. The fault isolation method of industrial process based on regularization framework of claim 1, wherein step 4 comprises the steps of:
step 4.1: obtaining a global regularization matrix G according to the improved similarity measurement algorithm and k-nearest neighbor (KNN) classification algorithm,
wherein G can be calculated by Formula (5),
G=S−W∈R^{n×n} (5)
wherein Formula (5) is further improved by a regularized Laplacian matrix to obtain Formula (6):
$$G = I - {S}^{- \frac{1}{2}} {WS}^{- \frac{1}{2}} ∈ {R}^{n \times n} \qquad ( 6 )$$
wherein I is the unit matrix of k×k; S is a diagonal matrix, wherein the diagonal elements are
$${S}_{ij} = {\sum }_{j = 1}^{n} {W}_{ij} ,$$
i=1, 2, . . . , n; W∈R^{n×n} is a similarity matrix; W and the sample point xᵢ|ᵢ₌₁ⁿ form an undirected weighted graph with the vertex corresponding to the sample point and the edge Wᵢⱼ corresponding to the similarity of the sample points xᵢ|ᵢ₌₁ⁿ and xⱼ|ⱼ₌₁^{b}; the precision of the final fault classification is determined by the calculation method of W, W is calculated by the method of local reconstruction using neighbor points of the sample point xᵢ, and the reconstruction error equation is as follows:
$${\sum }_{i = 1}^{n} {‖ {x}_{i} - {\sum }_{j = 1}^{k} {W}_{ij} {x}_{ij} ‖}^{2} \qquad ( 7 )$$
wherein
$${\sum }_{i = 1}^{k} {W}_{ij} = 1 ,$$
and the minimum value of Formula (7) is calculated to get W and then G by Formula (5); the specific steps for calculating W are as follows:
step 4.1.1: obtaining the distance measurement between xᵢ and its k neighbor points by the improved distance formula (8) to calculate the distance between sample points, i.e., sample similarity measurement;
$${W}_{ij} = d ( {x}_{i} , {x}_{j} ) = \frac{‖ {x}_{i} - {x}_{j} ‖}{\sqrt{M ( i ) M ( j )}} \qquad ( 8 )$$
M(i) and M(j) respectively represent the average value of distances between the sample point xᵢ and its k neighbors and the average value of distances between the sample point xⱼ and its k neighbors;
step 4.1.2: converting Formula (8) to Formula (9) through kernel mapping;
$$d ( {x}_{i} , {x}_{j} ) = \frac{\sqrt{{K}_{ii} - 2 {K}_{ij} + {K}_{jj}}}{\sqrt{Δ}} \qquad ( 9 )$$
wherein Kᵢⱼ=Φ(xᵢ)^{T}Φ(xⱼ), Kᵢᵢ=Φ(xᵢ)^{T}Φ(xᵢ), Kⱼⱼ=Φ(xⱼ)^{T}Φ(xⱼ), and K is Mercer kernel; the numerator \sqrt{Kᵢᵢ−2Kᵢⱼ+Kⱼⱼ} of Formula (9) is obtained by deducing the numerator ∥xᵢ−xⱼ∥ of Formula (8) through kernel mapping, i.e., ∥Φ(xᵢ)−Φ(xⱼ)∥=\sqrt{∥Φ(xᵢ)−Φ(xⱼ)∥²}=\sqrt{Kᵢᵢ−2Kᵢⱼ+Kⱼⱼ}; in the denominator of Formula (9),
$$Δ = \frac{{\sum }_{p = 1}^{k} ( {K}_{ii} - {K}_{{ii}^{p}} - {K}_{{i}^{p} i} + {K}_{{i}^{p} {i}^{p}} ) {\sum }_{q = 1}^{k} ( {K}_{jj} - {K}_{{jj}^{p}} - {K}_{{j}^{p} j} + {K}_{{j}^{p} {j}^{p}} )}{{k}^{2}} ,$$
wherein Kᵢᵢ_{^{p}}=Φ(xᵢ)^{T}Φ(xᵢ^{p}); Kᵢ_{^{p}}ᵢ=Φ(xᵢ^{p})^{T}Φ(xᵢ); Kᵢ_{^{p}}ᵢ_{^{p}}=Φ(xᵢ^{p})^{T}Φ(xᵢ^{p}); Kⱼⱼ_{^{q}}=Φ(xⱼ)^{T}Φ(xⱼ^{q}); Kⱼ_{^{q}}ⱼ=Φ(xⱼ^{q})^{T}Φ(xⱼ); Kⱼ_{^{q}}ⱼ_{^{q}}=Φ(xⱼ^{q})^{T}Φ(xⱼ^{q}); xᵢ^{p} (p=1, 2 . . . k) is the p th neighbor point of xᵢ; x_{q}^{j} (q=1, 2 . . . k) is the q th neighbor point of xⱼ;
step 4.1.3: defining the sample similarity measurement, i.e., distance measurement between samples, by Formula (9) according to the labeled data and the unlabeled data among the collected data, expressed by Formula (10):
$$d ( {x}_{i} , {x}_{j} ) = \{ \begin{matrix}\sqrt{1 - exp ( - \frac{{‖ {x}_{i} - {x}_{j} ‖}^{2}}{β} )} - α , & when {x}_{i} and {x}_{j} are labeled identically \\ \sqrt{1 - exp ( - \frac{{‖ {x}_{i} - {x}_{j} ‖}^{2}}{β} )} & when {x}_{i} and {x}_{j} are un labeled , {x}_{j} ∈ {N}_{i} or {x}_{i} ∈ {N}_{j} \\ \sqrt{exp ( - \frac{{‖ {x}_{i} - {x}_{j} ‖}^{2}}{β} )} , & otherwise\end{matrix} \qquad ( 10 )$$
wherein β is a control parameter depending on the distribution density of the collected sample data points; α is a regulation parameter;
step 4.1.4: getting k neighbors of the sample xᵢ by the distance measurement defined in Formula (10) to obtain the neighbor domain Nᵢ of xᵢ;
step 4.1.5: reconstructing xᵢ by k neighbor points of the sample xᵢ to calculate the minimum value of xᵢ reconstruction error, i.e., the optimal similarity matrix W:
$$argmin {\sum }_{i = 1}^{n} {‖ Φ ( {x}_{i} ) - {\sum }_{{x}_{j} ∈ {N}_{i}} {W}_{ij} Φ ( {x}_{i} ) ‖}^{2} \qquad ( 11 )$$
wherein Formula (7) is converted to Formula (11) through kernel mapping of sample points; ∥•∥ is an Euclidean noun; Wᵢⱼ has two constraint conditions:
$${\sum }_{{x}_{j} ∈ {N}_{i}} {W}_{ij} = 1 ,$$
and Wᵢⱼ=0 when xⱼ∉Nᵢ;
step 4.2: obtaining a local regularization matrix M;
step 4.3: obtaining the optimal solution F* of the objective function by making the partial derivative of the objective function J(F) for fault isolation in industrial process equal to 0;
$$\frac{\partial J}{\partial F} {\vert}_{F = {F}^{*}} = 2 D ( {F}^{*} - Y ) + 2 \frac{γ}{{n}^{2}} {GF}^{*} + 2 MF = 0 \\ ⇒ ( D + \frac{γ}{{n}^{2}} G + M ) {F}^{*} = DY \\ ⇒ {F}^{*} = {( D + \frac{γ}{{n}^{2}} G + M )}^{- 1} DY . \qquad ( 12 )$$

3. The fault isolation method of industrial process based on regularization framework of claim 2, wherein step 4.2 comprises the steps of:
step 4.2.1: determining k neighbor points of the sample point xᵢ through Euclidean distance, and defining the set of the k neighbor points as Nᵢ={xᵢ_{ⱼ}}ⱼ₌₁^{k}, wherein xᵢ_{ⱼ} represents the j th neighbor point of the sample point xᵢ;
step 4.2.2: establishing a loss function expressed by Formula (13) to cause sample classification labels to be distributed smoothly;
$$J ( {g}_{i} ) = {\sum }_{j = 1}^{k} {( {f}_{{i}_{j}} - {g}_{i} ( {x}_{{i}_{j}} ) )}^{2} + λ S ( {g}_{i} ) \qquad ( 13 )$$
wherein the first item is the sum of errors of the predicted classification labels and actual classification labels of all samples; λ is a regulation parameter; the second item S(gᵢ) is a penalty function; the function gᵢ:R^{m}→R, and
$${g}_{i} ( x ) = {\sum }_{j = 1}^{d} {β}_{i , j} {p}_{j} ( x ) + {\sum }_{j = 1}^{k} {α}_{i , j} {φ}_{i , j} ( x ) ,$$
which enable each sample point to reach a classification label through the mapping:
fᵢ_{ⱼ}=gᵢ(xᵢ_{ⱼ}), j=1,2, . . . ,k (14)
wherein fᵢ_{ⱼ} is the classification label of the j th neighbor point of the sample point xᵢ;
$$d = \frac{( m + s - 1 ) !}{m ! ( s - 1 ) !} ,$$
m is the dimension of x, and s is the partial derivative order of semi-norm; {pⱼ(x)}ᵢ₌₁^{d} constitutes polynomial space with the order not less than s, and 2s>m; φ_{i,j}(x) is a Green function; β_{i,j} and φ_{i,j} are two coefficients the Green function;
step 4.2.3: obtaining the estimated classification label loss of the set Nᵢ of neighbor points of the sample point xᵢ by calculating the minimum value of the loss function established in step 4.2.2,
wherein for k dispersed sample data points, the minimum value of the loss function J(gᵢ(x)) can be estimated by Formula (15),
$$J ( {g}_{i} ) \approx {\sum }_{j = 1}^{k} {( {f}_{{i}_{j}} - {g}_{i} ( {x}_{{i}_{j}} ) )}^{2} + λ {α}_{i}^{T} {H}_{i} {α}_{i} \qquad ( 15 )$$
wherein Hᵢ is the symmetric matrix of k×k, and its (r,z) elements are H_{r,z}=φ_{i,z}(xᵢ_{ᵣ}), αᵢ=[α_{i,1}, α_{i,2}, . . . , α_{i,k}]∈R^{k} and βᵢ=[β_{i,1}, β_{i,2}, . . . , β_{i,d-1}]^{T}∈R^{k}, wherein for a smaller λ, the minimum value of the loss function J(gᵢ(x)) can be estimated by the label matrix to obtain the estimated classification label loss of the set Nᵢ of neighbor points of the sample point xᵢ:
J(gᵢ)≈λFᵢ^{T}MᵢFᵢ (16)
wherein Fᵢ=[fᵢ_{₁}, fᵢ_{₂}, . . . , fᵢ_{ₖ}]∈R^{k} corresponds to the classification labels of k data in Nᵢ; Mᵢ is the upper left k×k subblock of the inverse coefficient matrix and is calculated by Formula (17):
αᵢ^{T}(Hᵢ+λI)αᵢ=Fᵢ^{T}MᵢFᵢ (17)
step 4.2.4: collecting the estimated classification label losses of the neighbor domains {Nᵢ}ᵢ₌₁ⁿ of n sample points together to obtain the total estimated classification label loss, and calculating the minimum value of the total loss E(f), i.e., the classification label of the sample data, so as to obtain the local regularization matrix M; the total estimated classification label loss is expressed by Formula (18),
$$E ( f ) \approx λ {\sum }_{i = 1}^{n} {F}_{i}^{T} {M}_{i} {F}_{i} \qquad ( 18 )$$
wherein f=[f₁, f₂, . . . , fₙ]^{T}∈Rⁿ is the vector of the classification label,
wherein when the coefficient λ in Formula (18) is neglected, Formula (18) is converted to Formula (19):
$$E ( f ) ∝ {\sum }_{i = 1}^{n} {F}_{i}^{T} {M}_{i} {F}_{i} \qquad ( 19 )$$
wherein according to the row selection matrix Sᵢ∈R^{k×n}, Fᵢ=Sᵢf; wherein the elements Sᵢ(u,v) in the u th row and the v th column of Sᵢ can be defined by Formula (20):
$${S}_{i} ( u , v ) = \{ \begin{matrix}1 , & if v = {i}_{u} \\ 0 , & otherwise\end{matrix} \qquad ( 20 )$$
wherein Fᵢ=Sᵢf is substituted into Formula (20) to obtain E(f)∝f^{T}Mf, wherein
$$M = {\sum }_{i = 1}^{n} {S}_{i}^{T} {M}_{i} {S}_{i} .$$
